(19) United States
(12) Patent Application Publication
(10) Pub. No.: US 2010/0306225 A1
(43) Pub. Date: Dec. 2, 2010

(54) Identifying Terms To Include In Content

(75) Inventors: Aleem R. Mawani, Markham, Ontario (CA); Adam Isaac Juda, New York, NY (US)

Correspondence Address: FISH & RICHARDSON P.C., PO BOX 1022, MINNEAPOLIS, MN, 55440-1022, US

(73) Assignee: GOOGLE INC., Mountain View, CA (US)

(21) Appl. No.: 12/552,593

(22) Filed: Sep. 2, 2009

Related U.S. Application Data
(60) Provisional application No. 61/182,174, filed on May 29, 2009.

(51) Int. Cl. G06F 17/30

(52) U.S. Cl. 707/759; 707/708

(57) ABSTRACT

A term to be included in an item is identified. A value of a first parameter of online activity associated with the term is determined. A determination that the value of the first parameter satisfies a first threshold is made and an item that includes the term is generated. The item is forwarded for placement in a medium. After the item has been placed in the medium, one or more search queries including the term are received over a predetermined time period. A value for a second parameter of online activity associated with the one or more search queries is determined. Based on the determined value of the second parameter, a determination that the placement of the item in the medium was effective is made.

### CROSS REFERENCE TO RELATED APPLICATION

This application claims priority to U.S. Provisional Application No. 61/182,174, which was filed on May 29, 2009, is titled “IDENTIFYING TERMS TO INCLUDE IN CONTENT,” and is incorporated by reference in its entirety.

### TECHNICAL FIELD

The following disclosure relates to placing content of an appropriate type in media.

### BACKGROUND

Content of different types may be placed in media. For example, advertisers provide advertisements (“ads”) in different forms in order to attract consumers. Types of ads include online ads that can be provided as banner advertisements on a web page, or an ad in a web page that can be presented, for example, in response to one or more keywords in a user search query input to a search engine. If a user selects the presented ad, the user is generally taken to another location associated with the ad, such as, for example, to an associated web page.

Offline electronic ads (e.g., commercials) can be provided with content in, for example, compact disks, electronic publications, and electronic billboards (e.g., in elevators, airports, and along roadways). Advertisers can submit a print ad to a publisher for inclusion in one or more printed publications, such as newspapers or magazines, for a price specified by the publisher. The advertisers typically also specify the placement of the print ad in the printed publication, including parameters such as the edition in which the print ad is to appear, the page on which the print ad is to run, and the size of the print ad.

### SUMMARY

An automated, scalable advertisement system may be implemented to manage content placement requests. The advertisement system may be implemented as an online, e.g., web-based, advertisement system. The advertisement system may include at least one processor connected to at least one storage device.

In one aspect, a term to be included in an item is identified. A value of a first parameter of online activity associated with the term is determined. A determination that the value of the first parameter satisfies a first threshold is made and an item that includes the term is generated. The item is forwarded for placement in a medium. After the item has been placed in the medium, one or more search queries including the term are received over a predetermined time period. A value for a second parameter of online activity associated with the one or more search queries is determined. Based on the determined value of the second parameter, a determination that the placement of the item in the medium was effective is made.

Implementations may include one or more of the following features. For example, the item may be a print advertisement.

Determining the value of the first parameter of online activity associated with the term may include determining a number of search queries including the term over a predetermined time period before the item is forwarded for placement in the medium. More particularly, a geographic region may be identified and the number of search queries including the term originating from the geographic region over the predetermined time period before the item is forwarded for placement in the medium may be determined. The geographic region may be identified by identifying a geographic distribution region of the medium in which the item is placed, and the number of search queries including the term originating from the geographic distribution region of the medium over the predetermined time period before the item is forwarded for placement in the medium may be determined.

The value of the first parameter of online activity associated with the term may be determined as a cost per selection of an online item that is presented in response to a search query including the term.

Identifying the term to be included in the item may include receiving the term to be included in the item, or generating a term that includes at least one of a name of an advertiser, a name of a product, a name of a publication, an identifier of a geographic distribution region of a publication, a month, and a year. Identifying the term to be included in the item also may include generating a phrase that includes two or more of a name of an advertiser, a name of a product, a name of a publication, an identifier of a geographic distribution region of a publication, a month, and a year.

Determining the value for the second parameter of online activity associated with the one or more search queries may include determining a number of search queries including the term over a predetermined time period after the item has been placed in the medium. For example, a geographic region may be identified and the number of search queries including the term over the predetermined time period after the item has been placed in the medium may be determined by determining a number of search queries including the term originating from the geographic region over the predetermined time period after the item has been placed in the medium.

Determining the value for the second parameter of online activity associated with the one or more search queries may include determining a number of selections of online content that are presented in response to a search query including the term over a predetermined time period after the item has been placed in media.

A second, online item that includes the term may be generated, and presentation, in response to reception of the one or more search queries including the term, of the second item may be enabled. When an indication of selection of the second item is received, determining the value for the second parameter of online activity associated with the one or more search queries may include determining a number of selections of the second item over a predetermined time period after the item has been placed in the medium.

Details of one or more implementations are set forth in the accompanying drawings and the description below. Other aspects can be implemented in systems and computers and will be apparent from the description and drawings, and from the claims.

### DESCRIPTION OF DRAWINGS

FIG. 1 is a flowchart showing an example process for evaluating the effectiveness of an ad using a term included in the ad.

FIG. 2 is a block diagram showing information that can be included in a term.

FIG. 3 is a flowchart showing an example process for determining whether a term satisfies a parameter and generating an ad including the term.

FIG. 4 is a flowchart showing an example process for determining whether a term satisfies a parameter and generating a print ad including the term and an online ad.

FIG. 5A shows an example of a print ad including a term.

FIG. 5B shows an example of an online ad.

FIG. 6 is a block diagram of an example electronic advertisement system.

FIG. 7 shows a schematic diagram of an example computer system.

Like reference symbols indicate like elements throughout the specification and drawings.

### DETAILED DESCRIPTION

Techniques, methods, apparatus, computer program products, and systems for content presentation (e.g., advertising) are described that can be used to facilitate print publication. Reference will be made herein to publication of ads, though publication of other forms of content items are possible. Print advertising as used herein refers to advertising occurring in print media, such as newspapers, magazines, journals, periodicals, flyers, brochures, and other printed publications. An ad placed in a printed publication shall be referred to herein as a “print ad.” While the discussion below makes reference to print ads for ease of illustration, the systems and methods disclosed herein can be applied to other forms of sponsored content, such as online ads, radio ads, and television ads.

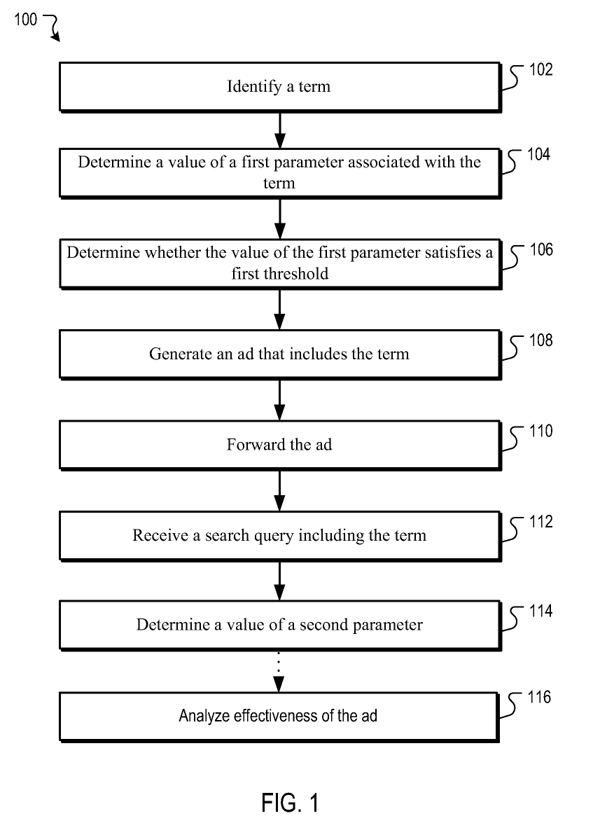

FIG. 1 is a flowchart showing an example process 100 for evaluating the effectiveness of an ad using a term included in the ad. In general, the process involves selecting a term that is rarely encountered, which may be referred to as a “long tail” term, and then monitoring whether the term is encountered more frequently after being placed in the ad. For example, if the term is a keyword that is rarely input into a search engine before being placed into an ad, the effectiveness of an ad including the keyword may be gauged by comparing the frequency with which the keyword is input into the search engine after being included in the ad to the frequency with which the keyword was input into the search engine before being included in the ad.

One or more steps in the process 100 can be carried out by, for example, an electronic system (e.g., an electronic advertisement system).

The electronic advertisement system initially identifies a term to be included in an advertisement (step 102). In some implementations, the term can originate from an advertiser. For example, an advertiser can submit the term to the system using, for example, a graphical user interface (“GUI”). In some implementations, the term can be generated by the electronic advertisement system. For example, the system can search through terms stored in the system for a term. In another example, the system can generate the term in response to a request from the advertiser for a term. In another example, the system can generate the term in response to a request from the advertiser for generation of an ad. In yet another example, the system can generate the term in response to a request from the advertiser for placement of an ad.

In some implementations, the term can relate to an advertiser and/or to a product. For example, the system can identify a term related to an advertiser based on terms on which the advertiser has previously bid. In some implementations, a term can be associated with another term on which the advertiser has previously bid if both terms share at least one word. In some implementations, a term can be associated with another term on which the advertiser has previously bid if advertisers who bid on one of the terms also bid on the other term.

In another example, the system can identify a term based on a characteristic of the advertiser and/or product. For example, if the advertiser is a computer manufacturer, a term associated with computer manufacturers can be identified. In another example, if a product is a vacuum, a term related to vacuums can be identified. In some implementations, identification of a term that is associated with a characteristic of the advertiser and/or product can be based on terms on which advertisers sharing the same characteristic, or advertisers promoting a similar product, have previously bid. For example, if other computer manufactures have previously bid on ‘chipset,’ the term ‘chipset’ can be identified.

In some implementations, the term can be a single word or a phrase including multiple words. For example, the phrase can include one or more of the name of the advertiser, the name of a product being advertised, the name of a publication in which the ad will be placed, an identifier of a geographic region, a month, a year, a date, content included within the ad, and content included within the publication in which the ad will be placed.

The system then determines a value of a first parameter associated with the term (step 104). In some implementations, the first parameter can be a number of search queries that include the term over a predetermined time period. For example, the predetermined time period can be a three month period before the term is identified or a three month time period before the ad that includes the term is forwarded to a content provider, such as a publisher. In some implementations, the first parameter can be a number of advertisers competing for the term. In some implementations, the first parameter can be a cost per selection of an online ad presented in response to a search query that includes the term. In one example, the cost per selection of the online ad can be determined at the time the term is identified. In another example, the cost per selection of the online ad can be the average cost per selection of the online ad over a predetermined time period.

In some implementations, the first parameter can be a cost per impression of an online ad presented in response to a search query that includes the term. In one example, the cost per impression of the online ad can be determined at the time the term is identified. In another example, the cost per impression of the online ad can be the average cost per impression of the online ad over a predetermined time period.

In some implementations, the first parameter can be a combination of two or more of the parameters discussed above, such as the number of search queries that include the term over a predetermined time period, the number of advertisers competing for the term, the cost per selection of an online ad presented in response to a search query that includes the term, and the cost per impression of an online ad presented in response to a search query that includes the term.

The system then determines whether the value of the first parameter satisfies a first threshold (step 106). In some implementations, to satisfy the first threshold, the value of the first parameter must either be less than a predetermined threshold or greater than a predetermined threshold. For example, if the first parameter is the number of advertisers competing for the term, less than five advertisers must be competing for the term to satisfy the first threshold.

In some implementations, to satisfy the first threshold, the value of the first parameter must be within a predetermined range of values. For example, if the first parameter is the number of search queries that include the term received over a five day period, more than ten search queries, but less than 100 search queries, must include the term over the five day period to satisfy the first threshold.

In some implementations where the first parameter is a combination of two or more of the parameters discussed above, to satisfy the first threshold, the value for each parameter must satisfy the first threshold. For example, if the first parameter is a combination of the number of advertisers competing for the term and the number of search queries that include the term received over a five day period, the value of the first parameter term may only satisfy the first threshold when less than five advertisers are competing for the term and between ten and one hundred search queries have included the term over the five day period.

In some implementations where the first parameter is a combination of two or more of the parameters discussed above, the value of the first parameter term may satisfy the first threshold when at least one of the values of the parameters included in the first parameter satisfies the first threshold. For example, if the first parameter is a combination of the number of advertisers competing for the term and the number of search queries that include the term received over a five day period, to satisfy the first threshold, less than five advertisers must be competing for the term or between ten and one hundred search queries must have included the term over the five day period.

In some implementations where the first parameter is a combination of two or more of the parameters discussed above, a weighted value is determined for each parameter included in the first parameter and is used to determine if the value of the first parameter satisfies the first threshold. For example, if the first parameter is a combination of the number of advertisers competing for the term and the number of search queries that include the term received over a five day period, it can be determined that three advertisers are competing for the term and that 50 search queries included the term over the five day period. For example, the number of competing advertisers, i.e., three, can be multiplied by a first weight and added to the number of search queries, i.e., 50, multiplied by a second weight to determine a weighted value for the first parameter. The value of the first parameter may only satisfy the first threshold when the weighted value is less than a predetermined threshold, greater than a predetermined threshold, or within a predetermined range.

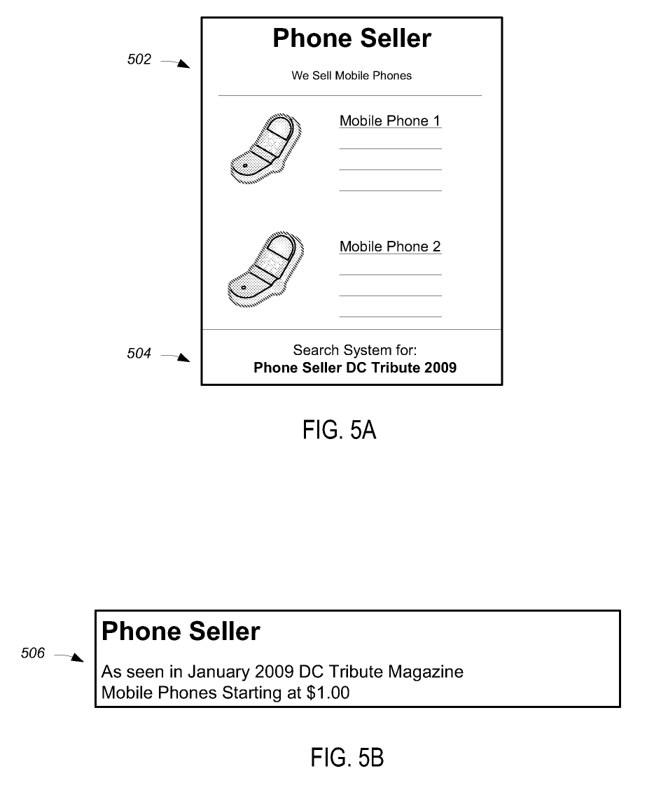

Next, the system generates an ad that includes the term (step 108). In some implementations, the ad can be a print ad, such as the print ad shown in FIG. 5A.

In some implementations, the advertiser can provide an ad without the term to the system. The system can then add the term to the received ad. In some implementations, the system can create the ad that includes the term. For example, the system can access existing online information such as contact information, geographic information, image information, product information, user review information, and/or auction information to create the ad. In another example, the advertiser can provide information to the system to include in the ad. In this example, the advertiser can upload an image and/or provide a product description, which the system can use to create the ad.

The system then forwards the ad (step 110). For example, the system can forward the ad to a content provider, such as a publisher, for placement in media, such as a publication. The system also can forward the ad to the advertiser or to a third party, such as an advertising agency, who can then forward the ad to the content provider for placement in media.

After the ad has been placed in media, a search query including the term can be received (step 112). For example, a consumer may view the ad in media and perform an online search using an online search engine for the term included in the ad to learn more. The search query can include only the term, or it can include the term and additional words.

Next, the system determines a value for a second parameter (step 114). In some implementations, the second parameter is a number of search queries that include the term received over a predetermined time period after the ad has been placed in media. For example, the second parameter can be a number of search queries that include the term received in the two-week period after the ad is first placed in media. In another example, the second parameter can be a number of search queries that include the term received over the duration of an ad campaign, e.g., the duration of time the ad is placed in media.

In some implementations, the second parameter is a number of selections or impressions of an online ad presented in response to a search query that includes the term over a predetermined time period after the ad has been placed in media. For example, the second parameter can be a number of selections or impressions that were received in the two-week period after the ad is first placed in media. In another example, the second parameter can be a number of selections or impressions that were received over the duration of an ad campaign, e.g., the duration of time the ad is placed in media.

In some implementations, the second parameter can be a combination of two or more of the parameters discussed above, i.e., the number of search queries that include the term received over a predetermined time period after the ad has been placed in media, the number of selections of an online ad presented in response to a search query that includes the term over a predetermined time period after the ad has been placed in media, and the number of impressions of an online ad presented in response to a search query that includes the term over a predetermined time period after the ad has been placed in media.

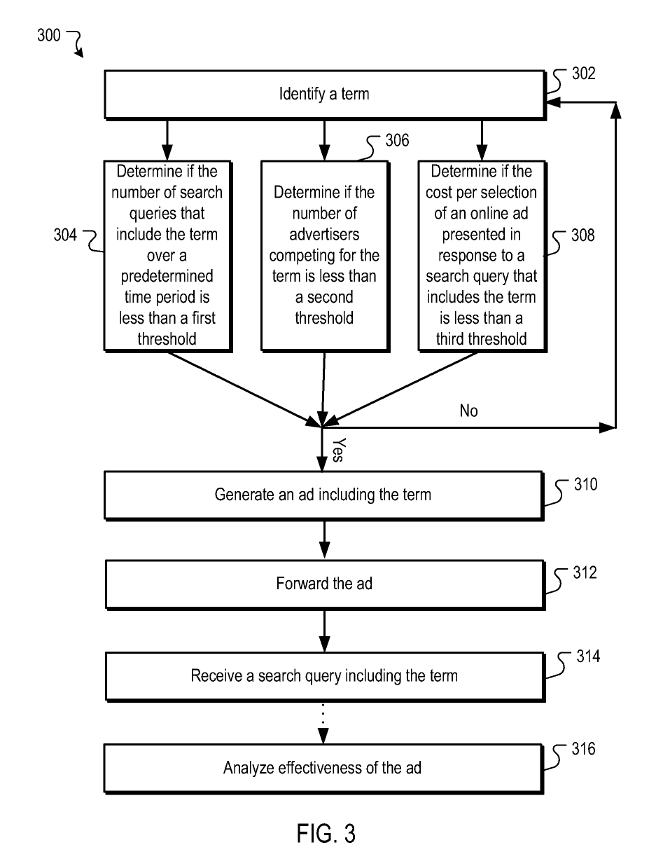

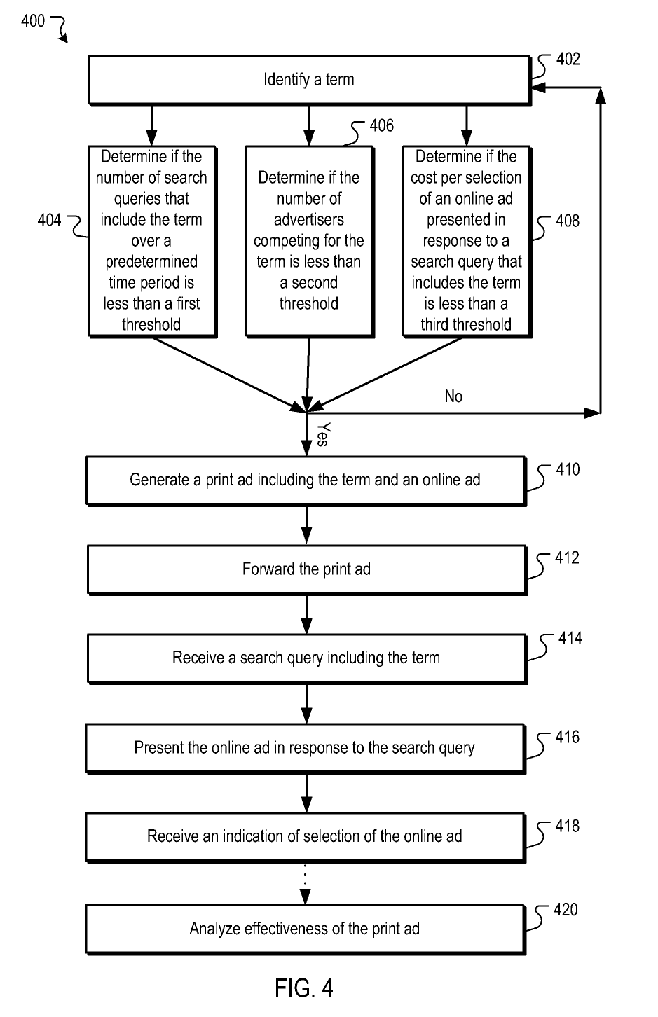

In some implementations, the system analyzes effectiveness of the ad based on the determined value of the second parameter (step 116). By monitoring the number of search queries that include the term, the number of selections of an online ad presented in response to a search query including the term, and/or the number of impressions of an online ad presented in response to a search query that includes the term, the consumer response and, therefore, the effectiveness of the ad can be analyzed, as described in greater detail below in connection with FIGS. 3 and 4.

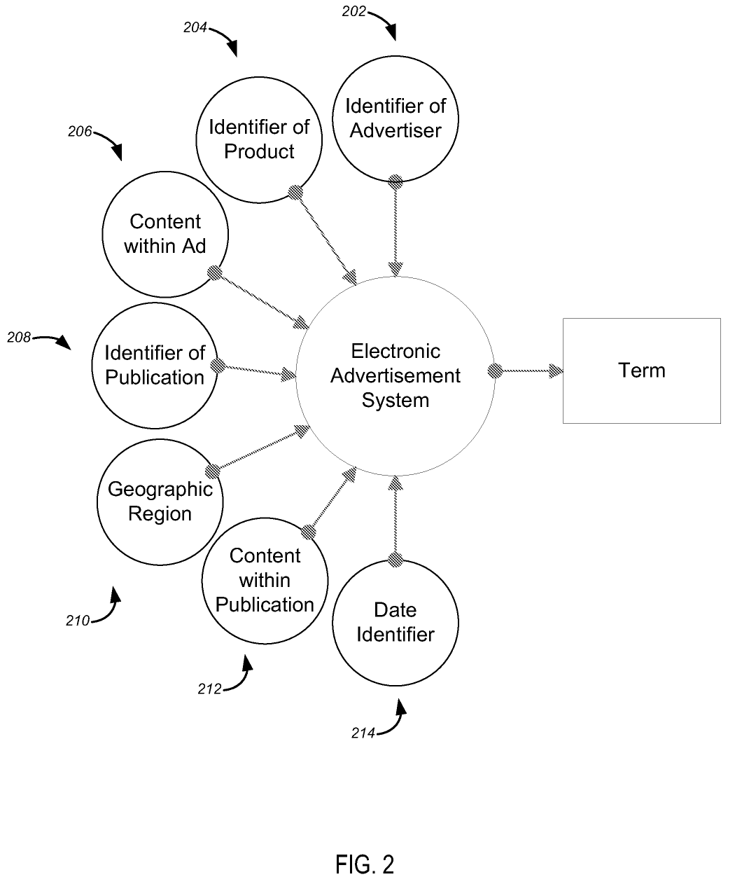

FIG. 2 is a block diagram showing information 202-214 that can be included in a term. Some or all of the information 202-214 can be included in the term.

The identifier of the advertiser 202 can include a name and/or a trademark of the advertiser. If the ad promotes more than one advertiser, the term can include the identifier of only one advertiser, or the identifiers of the two or more advertisers.

The identifier of the product 204 can include a name and/or trademark of a product promoted in the ad. If the ad promotes more than one product, the term can include the identifier of only one product or the identifiers of the two or more products.

The content within the ad 206 can include any information included in the ad. In some implementations, the ad can include a description of a product and one or more words included in the description of the product can be included in the term. In other implementations, the ad can include an address of an advertiser and the street name, city, state, county, country, and/or postal code included in the address can be included in the term.

The identifier of the publication 208 can include a title, a name of the publisher, and/or a trademark of the publication in which the ad will be placed. For example, if the ad will be placed in ‘Search Engines Monthly’ magazine, ‘Search Engines Monthly’ can be included in the term. In another example, if ‘Search Engines Monthly’ is published by the publisher ‘Searchers,’ ‘Searchers’ can be included in the term.

The geographic region 210 can include an identifier of a particular geographic region. For example, the particular geographic region can be the distribution region of the publication in which the ad will be placed. In some implementations, the identifier of the particular geographic region can be an identifier of a neighborhood, an identifier of a city, an identifier of a county, an identifier of a metropolitan area, an identifier of a state, an identifier of a region of a country, an identifier of a country, and/or an identifier of a region in the world. For example, if ‘Search Engines Monthly’ magazine is distributed in New York City, the identifier ‘NYC’ can be included in the term. In another example, if ‘Search Engines Monthly’ magazine if distributed across the United States, the identifier ‘US’ can be included in the term.

The content within the publication 212 can include any information included in the publication. The content within the publication can be related to the ad and/or content located near where the ad will be placed in the publication. For example, if the ad is placed in the sports section of a newspaper, ‘sports’ can be included in the term. In another example, if the ad will be placed inline with an article about cholesterol, ‘cholesterol’ can be included in the term.

The date identifier 214 can include an identifier of a particular time period. In some implementations, the time period can be the start date of an ad campaign. The date can include the time, day, month, and/or year in which the ad is placed in media. For example, if the ad is placed in the January 2009 edition of ‘Search Engines Monthly’ magazine, ‘January’ and/or ‘2009’ can be included in the term. In another example, if the ad is placed in the May 24, 2008 edition of a newspaper, ‘May,’ ‘24,’ and/or ‘2008’ can be included in the term.

FIG. 3 is a flowchart showing an example process 300 for determining whether a term satisfies a parameter and generating an ad that includes the term. One or more steps in the process 300 can be carried out by, for example, an electronic system (e.g., an electronic advertisement system).

A term is initially identified (step 302). As described above in connection with step 102, the term can originate from an advertiser and/or can be generated by the electronic advertisement system. The term can include one or more words and include some or all of the information described above in connection with FIG. 2.

The system determines whether the term satisfies one or more parameters (steps 304, 306, 308). In some implementations, the system can determine whether the identified term satisfies a single parameter, in which case only one of steps 304, 306, or 308 is performed by the system. In other implementations, the system can determine whether the identified term satisfies multiple parameters, in which case two or more of steps 304, 306, or 308 are performed by the system. Additional steps can be included in process 300 to determine whether the term satisfies other parameters. For example, an additional step can be included in process 300 to determine if the cost per impression of an online ad presented in response to a search query that includes the term is less than a predetermined threshold.

When the system determines whether the identified term satisfies multiple parameters, steps 304, 306, or 308 can be performed in parallel, as illustrated in FIG. 3. Steps 304, 306, or 308 can also be serially performed.

The system can determine if the number of search queries that include the term received over a predetermined time period is less than a first threshold by comparing the number of search queries to the first threshold (step 304). The search queries can include search queries received from users at an online search engine that can be included as part of the electronic system, or can be separate from the electronic system. The predetermined time period can be, for example, a three month period before the term is identified. The system can determine if the number of search queries that include the term is greater than a predetermined threshold and/or within a predetermined range.

The system can determine if the number of advertisers competing for the term is less than a second threshold by comparing the number of advertisers to the second threshold (step 306). The second threshold can be different from the first threshold. The number of advertisers competing for the term can be, for example, the number of advertisers bidding for the term at an online search engine. The number of advertisers can be determined at the time the term is identified. In some implementations, the average number of advertisers competing for the term over predetermined time period, such as a three month period before the term is identified, can be determined. The system can determine if the number of advertisers competing for the term is greater than a predetermined threshold and/or within a predetermined range.

The system can determine if the cost per selection of an online ad presented in response to a search query that includes the term is less than a third threshold by comparing the cost per selection to the third threshold (step 308). The third threshold can be different from the first and second thresholds. The cost per selection of an online ad presented in response to a search query that includes the term can be, for example, the highest amount bid for the term by advertisers at an online search engine over a predetermined time period, or the average amount bid for the term by advertisers at an online search engine over a predetermined time period. The system can determine if the cost per selection of an online ad presented in response to a search query that includes the term is greater than a predetermined threshold and/or within a predetermined range.

If the term satisfies the first parameter (e.g., the condition of one or more of steps 304, 306, or 308 is true), the system generates an ad including the term (step 310). Alternatively, if the term does not satisfy the first parameter (e.g., the condition of one or more of steps 304, 306, or 308 is false), the system returns to step 302 to identify a different term. For example, if the term must satisfy all of the parameters of steps 304, 306, and 308, and at least one of the parameters is not satisfied, the system returns to step 302. In another example, if the term must satisfy one of the parameters of steps 304, 306, and 308, and at least one of the parameters is satisfied, the system generates an ad including the term in step 310.

As described above in connection with step 104, in some implementations, the advertiser can provide an ad to the system and the system can add the term to the ad. The system can create the ad that includes the term. For example, the system can access existing online information such as contact information, geographic information, image information, product information, user review information, and/or auction information to create the ad. In another example, the advertiser can provide information to the system to include in the ad. In this example, the advertiser can upload an image and/or provide a product description that the system can use to create the ad.

After the ad is generated, the system forwards the ad (step 312). For example, the system can forward the ad to a content provider, such as a publisher, for placement in media, such as a publication. The system also can forward the ad to the advertiser or to a third party, such as an advertising agency, who can then forward the ad to the content provider for placement in media.

After the ad has been placed in media, a search query including the term can be received (step 314). The user can search for the term using an online search engine. The search query can include only the term, or it can include the term and additional words.

In some implementations, the effectiveness of the ad can be analyzed (step 316). The system can monitor one or more parameters, such as the examples of the second parameters described above in connection with step 106, to analyze the effectiveness of the ad. In some implementations, a number of search queries that include the term received over a predetermined time period after the ad has been placed in media can be monitored to analyze the effectiveness of the ad. In some implementations, if the number of search queries that include the term received over the predetermined time period after the ad has been placed in media is greater than a predetermined threshold, it can be determined that the ad was effective.

In some implementations, the number of search queries that include the term received over the predetermined time period after the ad has been placed in media can be compared to a number of search queries that include the term received over the predetermined time period before the ad has been placed in media. For example, the number of search queries that include the term received during the week after the ad is placed in media can be compared to the number of search queries that include the term received during the week before the ad is placed in media. If the number of search queries received after the ad is placed is significantly greater (e.g., more than two standard deviations) than the number of search queries received before the ad is placed, it can be determined that the ad was effective.

In some implementations, the difference between the number of search queries that include the term received after the ad is placed and the number of search queries that include the term received before the ad is placed can be compared to a threshold to determine if the ad was effective. For example, if the difference is greater than the threshold, it can be determined that the ad was effective.

In some implementations, a daily average number of search queries that include the term received over a predetermined time period after the ad has been placed in media can be monitored to analyze the effectiveness of the ad. The daily average number of search queries that include the term received during a predetermined time period before the ad is placed in media can be compared to a daily average number of search queries that include the term received during a predetermined time period after the ad is placed in media. The predetermined time period before the ad is placed can be the same as, or different from, the predetermined time period after the ad is placed.

For example, a daily average number of search queries that include the term received during a three month period before the ad is placed in media can be compared to a daily average number of search queries that include the term received during a one week period after the ad is placed in media. If the daily average number received after the ad is placed is significantly greater (e.g., more than two standard deviations) than the daily average number before the ad is placed, it can be determined that the ad was effective.

In some implementations, the difference between the daily average number received after the ad is placed and the daily average number received before the ad is placed can be compared to a threshold to determine if the ad was effective. For example, if the difference is greater than the threshold, it can be determined that the ad was effective.

A number of search queries that include the term and that are received from a particular geographic region over a predetermined time period after the ad has been placed in media can be monitored to analyze the effectiveness of the ad. For example, this number of search queries can be compared to a number of search queries that include the term and that are received from the particular geographic region over the predetermined time period before the ad is placed in media. The particular geographic region can be the geographic distribution region of the media in which the ad is placed. For example, if the media is distributed in the state of Virginia, the number of search queries that include the term and that are received from Virginia during the week after the ad is placed in media can be compared to the number of search queries that include the term and that are received from Virginia during the week before the ad is placed in media. If the number of search queries that include the term received after the ad is placed is significantly greater (e.g., more than two standard deviations) than the number of search queries that include the term received before the ad is placed, it can be determined that the ad was effective.

In some implementations, the difference between the number of search queries that include the term received after the ad is placed and the number of search queries that include the term received before the ad is placed can be compared to a threshold to determine if the ad was effective. For example, if the difference is greater than the threshold, it can be determined that the ad was effective.

In some implementations, the number of search queries that include the term and that originate from the particular geographic region over the predetermined time period after the ad is placed in media can be compared to a number of search queries that include the term and that originate from a different geographic region over the predetermined time period after the ad is placed in media. If the number of search queries that include the term received from the particular geographic region is significantly (e.g., more than two standard deviations) greater that the number of search queries that include the term received from the different geographic region, it can be determined that the ad was effective.

The difference between the number of search queries that include the term received from the particular geographic region after the ad is placed and the number of search queries that include the term received from the different geographic region after the ad is placed can be compared to a threshold to determine if the ad was effective. For example, if the difference is greater than the threshold, it can be determined that the ad was effective.

The number of search queries that include the term and that originate from the particular geographic region over the predetermined time period after the ad is placed in media can be compared to the number of search queries that include the term and that originate from the particular geographic region over the predetermined period of time before the ad is placed in media to determine a first difference. In addition, the number of search queries that include the term and that originate from a different geographic region over the predetermined time period after the ad is placed in media can be compared to a number of search queries that include the term and that originate from the different geographic region over the predetermined period of time before the ad is placed in media to determine a second difference. If the first difference is significantly greater (e.g., more than two standard deviations) than the second difference, it can be determined that the ad was effective.

The difference between the first difference and the second difference can be compared to a threshold to determine if the ad was effective. For example, if the difference between the two differences is greater than the threshold, it can be determined that the ad was effective.

In some implementations, the different geographic region can be selected based on a high correlation (e.g., greater than 0.9) over a predetermined time period between the number of search terms that include the term received in the particular geographic region and the number of search terms that include the term received in the different geographic region before the ad is placed in media.

In some implementations, a number of impressions or selections of an online ad presented in response to a search query that includes the term over a predetermined time period after the ad has been placed in media can be used to analyze the effectiveness of the ad, as described in greater detail below in connection with step 420.

A combination of two or more of the number of search queries that include the term over a predetermined time period after the ad has been placed in media, the number of impressions of an online ad presented in response to a search query that includes the term over a predetermined time period after the ad has been placed in media, and the number of selections of an online ad presented in response to a search query that includes the term over a predetermined time period after the ad has been placed in media can be used to analyze the effectiveness of the ad.

FIG. 4 is a flowchart showing an example process 400 for determining whether a term satisfies a parameter and generating a print ad including the term and an online ad. One or more steps in the process 400 can be carried out by, for example, an electronic system (e.g., an electronic advertisement system).

A term is initially identified (step 402), as described above in connection with step 302. The system determines whether the term satisfies one or more parameters (steps 404, 406, 408), as described above in connection with steps 304, 306, and 308. If the term satisfies the first parameter (e.g., the condition of one or more of steps 404, 406, or 408 is true), the system generates a print ad including the term and an online ad (step 410). Alternatively, if the term does not satisfy the first parameter (e.g., the condition of one or more of steps 404, 406, or 408 is false), the system returns to step 402 to identify a different term. For example, if the term must satisfy all of the parameters of steps 404, 406, and 408, and at least one of the parameters is not satisfied, the system returns to step 402. In another example, if the term must satisfy one of the parameters of steps 404, 406, and 408, and at least one of the parameters is satisfied, the system generates the print ad including the term and the online ad in step 410.

The print ad including the term is generated in step 410, as described above in connection with step 310. Generation of the online ad can include receiving the online ad from an advertiser or having the system create the online ad. For example, the system can access existing online information such as contact information, geographic information, image information, product information, user review information, and/or auction information to create the online ad. In another example, the advertiser can provide information to the system to include in the online ad. In this example, the advertiser can upload an image and/or provide a product description, which the system can use to create the online ad.

In some implementations, the online ad can identify a characteristic of the publication in which the print ad is placed. For example, as shown on FIG. 5B, the online ad identifies the edition (e.g., “January 2009”) and the name (e.g., “DC Tribute Magazine”) of the publication in which the print ad is placed. In some implementations, the online ad can also include the term.

The online ad can include the same information as the ad. For example, if a product is promoted in the print ad, the online ad can also promote the same product. In some implementations, the online ad can include different information. For example, as shown in FIG. 5B, the online ad does not include product information, while the print ad, as shown in FIG. 5A, does include product information.

After the print ad including the term and the online ad are generated, the system forwards the print ad (step 412). The system can forward the print ad to a publisher for placement in a publication media, or to the advertiser and/or to a third party, who can then forward the print ad to the publisher for placement in the publication.

After the print ad has been placed in the publication, a search query including the term can be received (step 414), as described above in connection with step 314. The online ad can be presented in response to the search query including the term (step 416). If a user is interested in learning more about the online ad, the user can select the online ad to be directed to another webpage, such as a webpage associated with the advertiser. An indication of selection of the online ad is received by the system (step 418).

In some implementations, the effectiveness of the print ad can be analyzed (step 420). The system can monitor one or more parameters, such as the examples of second parameters described above in connection with step 106, to analyze the effectiveness of the print ad. In some implementations, a number of search queries that include the term received over a predetermined time period after the print ad has been placed in the publication can be used to analyze the effectiveness of the print ad, as similarly described above in connection with step 316.

In some implementations, a number of impressions or selections of the online ad over a predetermined time period after the print ad has been placed in the publication can be used to analyze the effectiveness of the print ad. For example, if the number of impressions of the online ad over the predetermined time period after the print ad has been placed in the publication is greater than a predetermined threshold, it can be determined that the print ad was effective.

As one example, a daily average number of impressions or selections of the online ad over a predetermined time period after the print ad has been placed in the publication can be monitored to analyze the effectiveness of the print ad. If the daily average number of impressions of the online ad over the predetermined time period after the print ad has been placed in the publication is greater than a predetermined threshold, it can be determined that the print ad was effective.

A number of impressions or selections of the online ad to a particular geographic region over a predetermined time period after the print ad has been placed in the publication can be monitored to analyze the effectiveness of the print ad. The particular geographic region can be the geographic distribution region of the publication in which the print ad is placed. In such implementations, if the number of impressions of the online ad to the particular geographic region over the predetermined time period after the print ad has been placed in the publication is greater than a predetermined threshold, it can be determined that the print ad was effective.

A combination of two or more of the number of search queries that include the term over a predetermined time period after the print ad has been placed in the publication, the number of impressions of the online ad over a predetermined time period after the print ad has been placed in the publication, and the number of selections of the online ad over a predetermined time period after the print ad has been placed in the publication can be used to analyze the effectiveness of the ad.

FIG. 5A shows an example of a print ad 502 including the term 504, generated in connection with processes 100, 300, and 400. As shown in FIG. 5A, the print ad 502 includes the name of an advertiser, i.e., “Phone Seller,” a description of the advertiser, i.e., “We Sell Mobile Phones,” the names of two products, i.e., “Mobile Phone 1” and “Mobile Phone 2,” the descriptions of the two products, and the term 504, i.e., “Phone Seller DC Tribute 2009.” A viewer of the print ad 502 is encouraged to search for the term “Phone Seller DC Tribute 2009” using the system.

The term “Phone Seller DC Tribute 2009” includes the name of the advertiser, i.e., “Phone Seller,” the name of the publication in which the ad will be placed, i.e., “DC Tribute,” and the year in which the ad will be placed, i.e., “2009.” The term “Phone Seller DC Tribute 2009” is determined by the system to satisfy the first parameter, as described above in connections with processes 100, 300, and 400.

Although the term 504 is shown to be at the bottom of the print ad 502, it could be located anywhere in the print ad 502, such as, for example, in the middle of the print ad 502, at the top of the print ad 502, at the left of the print ad 502, or at the right of the print ad 502.

FIG. 5B shows an online ad 506 that is presented in response to a search query that includes the term. The online ad 506 includes the name of the advertiser, i.e., “Phone Seller.” The online ad 506 also identifies the edition (e.g., “January 2009”) and the name (e.g., “DC Tribute Magazine”) of the publication in which the print ad is placed so that users viewing the online ad can recognize that it corresponds to the print ad 502. The online ad 506 also includes addition information about the advertiser and/or products (e.g., “Mobile Phones Starting at $1.00”) to encourage users to select the online ad. In some implementations, the online ad can also include the term.

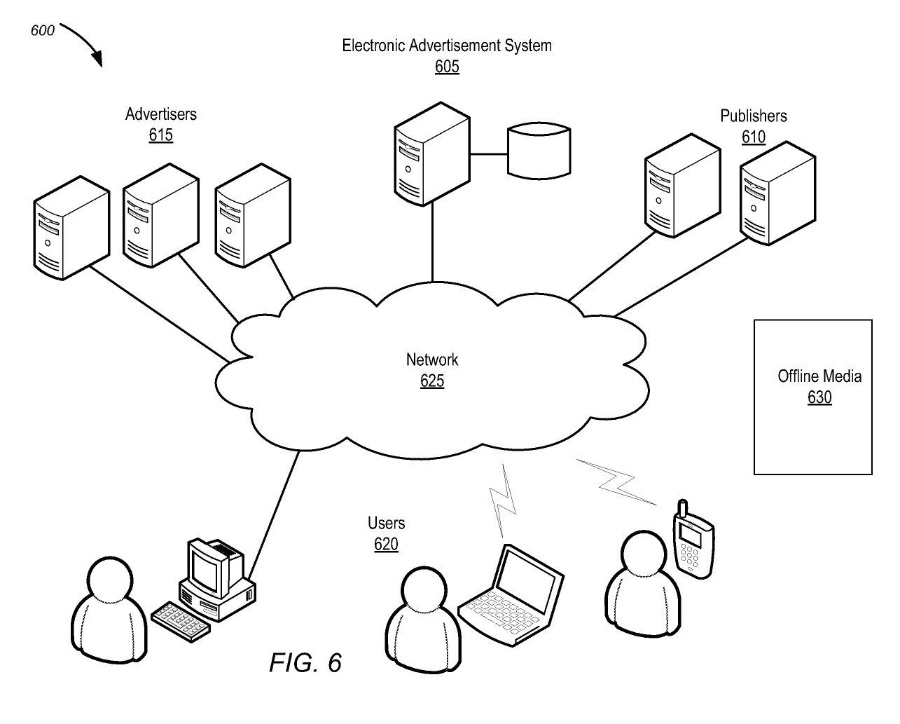

FIG. 6 is a block diagram of an example advertising system 600. The advertising system 600 includes advertisers 615, the electronic advertisement system 605, publishers 610, and users 620. A publisher 610 is an entity that publishes content or places content for publication with another entity. An advertiser 615 is an entity that desires to place a print ad in a printed publication. The advertiser 615 can be a direct (e.g., an advertising entity) or indirect supplier (e.g., a middle man) of the print ad. In some implementations, the advertiser 615 and one or more of the publishers 610 can have a specified relationship, such as a previous advertising relationship.

The system further includes an electronic advertisement system 605. The electronic advertisement system 605 operates to bring the advertisers 615 and publishers 610 together. Each of these entities can be coupled to a network 625 (e.g., the Internet) using one or more communication channels (e.g., wireless, optical, Ethernet). The advertising system 600 also includes offline media 630, such as, for example, print media, television media, and radio media. The advertisements within offline media 630 can be monitored by the electronic advertisement system 605.

The functional operations described can be implemented in digital electronic circuitry, or in computer hardware, firmware, software, or in combinations of them. The electronic advertisement system 605 can be implemented in a computer program product tangibly embodied in a machine-readable storage device for execution by a programmable processor. The steps performed by the electronic advertisement system 605 can be performed by a programmable processor executing a program of instructions to perform functions by operating on input data and generating output.

The electronic advertisement system 605 can be implemented in one or more computer programs that are executable on a programmable system including at least one programmable processor coupled to receive data and instructions from, and to transmit data and instructions to, a data storage system, at least one input device, and at least one output device. Each computer program can be implemented in a high-level procedural or object-oriented programming language, or in assembly or machine language if desired; and in any case, the language can be a compiled or interpreted language.

Suitable processors include, by way of example, both general and special purpose microprocessors. Generally, a processor will receive instructions and data from a read-only memory and/or a random access memory. Generally, a computer will include one or more mass storage devices for storing data files; such devices include magnetic disks, such as internal hard disks and removable disks; a magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM disks. Any of the foregoing can be supplemented by, or incorporated in, ASICs (application-specific integrated circuits).

To provide for interaction with a user, the electronic advertisement system 605 can be implemented on a computer system having a display device such as a monitor or LCD screen for displaying information to the user and a keyboard and a pointing device such as a mouse or a trackball by which the user can provide input to the computer system. The computer system can be programmed to provide a GUI through which computer programs interact with users.

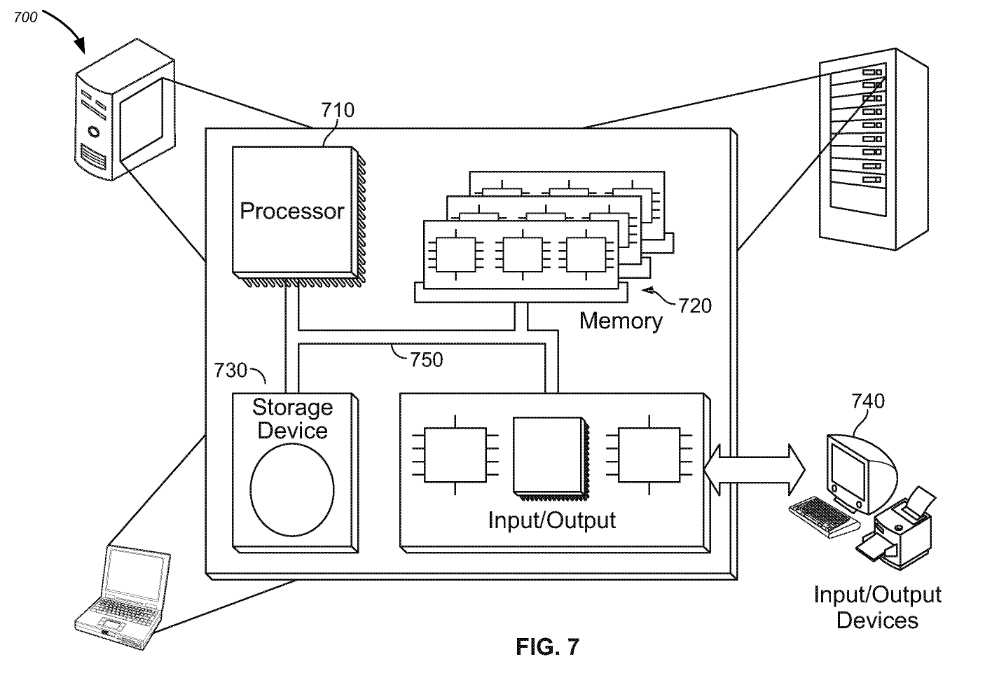

FIG. 7 shows a schematic diagram of an example computer system 700 that can be used to implement a server hosting the electronic advertisement system 605, the advertisers 615, and/or the publishers 610.

The system 700 includes a processor 710, a memory 720, a storage device 730, and an input/output device 740. Each of the components 710, 720, 730, and 740 can, for example, be interconnected using a system bus 750. The processor 710 is capable of processing instructions for execution within the system 700. In one implementation, the processor 710 is a single-threaded processor. In another implementation, the processor 710 is a multi-threaded processor. The processor 710 is capable of processing instructions stored in the memory 720 or on the storage device 730 to display graphical information for a user interface on the input/output device 740. In some embodiments, a parallel processing set of systems 700 connected over a network may be employed, clustered into one or more server centers.

The memory 720 stores information within the system 700. In one implementation, the memory 720 is a computer-readable medium. In one implementation, the memory 720 is a volatile memory unit. In another implementation, the memory 720 is a non-volatile memory unit.

The storage device 730 is capable of providing mass storage for the system 700. In one implementation, the storage device 730 is a computer-readable medium. In various different implementations, the storage device 730 can, for example, include a hard disk device, an optical disk device, or some other large capacity storage device.

The input/output device 740 provides input/output operations for the system 700. In one implementation, the input/output device 740 includes a keyboard and/or pointing device. In another implementation, the input/output device 740 includes a display unit for displaying GUIs.

A module can be a piece of hardware that encapsulates a function, can be firmware or can be a software application. A module can perform one or more functions, and one piece of hardware, firmware or software can perform the functions of more than one of the modules described herein. Similarly, more than one piece of hardware, firmware and/or software can be used to perform the function of a single module described herein.

It is to be understood the implementations are not limited to particular systems or processes described which may, of course, vary. It is also to be understood that the terminology used herein is for the purpose of describing particular implementations only, and is not intended to be limiting. As used in this specification, the singular forms a “an” and “the” include plural referents unless the content clearly indicates otherwise. Thus, for example, reference to “a publisher” includes two or more publishers and reference to “an ad” includes a combination of two or more different types of ads.

A number of implementations have been described. Nevertheless, it will be understood that various modifications may be made without departing from the spirit and scope of the claims. For example, more than one ad including different terms can be placed in media distributed in different geographic regions, in the same geographic region at the same time, or in the same geographic region at different times for a particular advertiser. The most effective print ad can be determined based on the analysis of each ad, as each includes a different term. For example, the term included the highest number of search queries can be determined to be the most effective. In another example, the term associated with the highest number of impressions of an online ad presented in response to a search query including the term can be determined to be the most effective. In another example, the term associated with the highest number of selection of an online ad presented in response to a search query including the term can be determined to be the most effective.

Accordingly, other implementations are within the scope of this application.

What is claimed is:

1. A method comprising:
identifying a term to be included in an item;
determining a value of a first parameter of online activity associated with the term;
determining that the value of the first parameter satisfies a first threshold;
generating, based on the determination that the value of the first parameter satisfies the first threshold, the item that includes the term;
forwarding the item for placement in a medium, the medium being in a format that is different from online;
receiving one or more search queries including the term over a predetermined time period after the item has been placed in the medium;
determining a value for a second parameter of online activity associated with the one or more search queries; and
determining, based on the determined value of the second parameter, that the placement of the item in the medium was effective.

2. The method of claim 1, wherein the item is a print advertisement.

3. The method of claim 1, wherein determining the value of the first parameter of online activity associated with the term comprises determining a number of search queries including the term over a predetermined time period before the item is forwarded for placement in the medium.

4. The method of claim 3, further comprising identifying a geographic region, wherein determining the number of search queries including the term over the predetermined time period before the item is forwarded for placement in the medium comprises determining a number of search queries including the term originating from the geographic region over the predetermined time period before the item is forwarded for placement in the medium.

5. The method of claim 4, wherein:
identifying the geographic region comprises identifying a geographic distribution region of the medium in which the item is placed, and
determining the number of search queries including the term originating from the geographic region over the predetermined time period before the item is forwarded for placement in the medium comprises determining a number of search queries including the term originating from the geographic distribution region of the medium over the predetermined time period before the item is forwarded for placement in the medium.

6. The method of claim 1, wherein determining the value of the first parameter of online activity associated with the term comprises determining a cost per selection of an online item that is presented in response to a search query including the term.

7. The method of claim 1, wherein identifying the term to be included in the item comprises receiving the term to be included in the item.

8. The method of claim 1, wherein identifying the term to be included in the item comprises generating a term that includes at least one of a name of an advertiser, a name of a product, a name of a publication, an identifier of a geographic distribution region of a publication, a month, and a year.

9. The method of claim 1, wherein identifying the term to be included in the item comprises generating a phrase that includes two or more of a name of an advertiser, a name of a product, a name of a publication, an identifier of a geographic distribution region of a publication, a month, and a year.

10. The method of claim 1, wherein determining the value for the second parameter of online activity associated with the one or more search queries comprises determining a number of search queries including the term over a predetermined time period after the item has been placed in the medium.

11. The method of claim 10, further comprising identifying a geographic region, wherein determining the number of search queries including the term over the predetermined time period after the item has been placed in the medium comprises determining a number of search queries including the term originating from the geographic region over the predetermined time period after the item has been placed in the medium.

12. The method of claim 1, wherein determining the value for the second parameter of online activity associated with the one or more search queries comprises determining a number of selections of online content that is presented in response to a search query including the term over a predetermined time period after the item has been placed in media.

13. The method of claim 1, further comprising:
generating a second item that includes the term, wherein the second item is an online item;
enabling presentation, in response to reception of the one or more search queries including the term, of the second item; and
receiving an indication of selection of the second item, wherein determining the value for the second parameter of online activity associated with the one or more search queries comprises determining a number of selections of the second item over a predetermined time period after the item has been placed in the medium.

14. A system comprising at least one processor connected to at least one storage device, wherein the at least one processor is configured to:
identify a term to be included in an item;
determine a value of a first parameter of online activity associated with the term;
determine that the value of the first parameter satisfies a first threshold;
generate, based on the determination that the value of the first parameter satisfies the first threshold, the item that includes the term;
forward the item for placement in a medium, the medium being in a format that is different from online;
receive one or more search queries including the term over a predetermined time period after the item has been placed in the medium;
determine a value for a second parameter of online activity associated with the one or more search queries; and
determine, based on the determined value of the second parameter, that the placement of the item in the medium was effective.

15. The system of claim 14, wherein the at least one processor is configured to determine the value of the first parameter of online activity associated with the term by determining a number of search queries including the term over a predetermined time period before the item is forwarded for placement in the medium.

16. The system of claim 14, wherein the at least one processor is configured to determine the value for the second parameter of online activity associated with the one or more search queries by determining a number of search queries including the term over a predetermined time period after the item has been placed in the medium.

17. The system of claim 14, wherein the at least one processor is further configured to:
generate a second item that includes the term, wherein the second item is an online item;
enable presentation, in response to reception of the one or more search queries including the term, of the second item; and
receive an indication of selection of the second item, wherein determining the value for the second parameter of online activity associated with the one or more search queries comprises determining a number of selections of the second item over a predetermined time period after the item has been placed in the medium.

18. A storage device storing a computer program, the computer program comprising one or more code segments that, when executed, cause at least one processor to:
identify a term to be included in an item;
determine a value of a first parameter of online activity associated with the term;
determine that the value of the first parameter satisfies a first threshold;
generate, based on the determination that the value of the first parameter satisfies the first threshold, the item that includes the term;
forward the item for placement in a medium, the medium being in a format that is different from online;
receive one or more search queries including the term over a predetermined time period after the item has been placed in the medium;
determine a value for a second parameter of online activity associated with the one or more search queries; and
determine, based on the determined value of the second parameter, that the placement of the item in the medium was effective.

19. The storage device of claim 18, wherein the one or more code segments that, when executed, cause the at least one processor to determine the value of the first parameter of online activity associated with the term comprise one or more code segments that, when executed, cause the at least one processor to determine a number of search queries including the term over a predetermined time period before the item is forwarded for placement in the medium.

20. The storage device of claim 18, wherein the one or more code segments that, when executed, cause the at least one processor to determine the value for the second parameter of online activity associated with the one or more search queries comprise one or more code segments that, when executed, cause the at least one processor to determine a number of search queries including the term over a predetermined time period after the item has been placed in the medium.
